(19) United States
(12) Patent Application Publication
(10) Pub. No.: US 2023/0053684 A1
(43) Pub. Date: Feb. 23, 2023

(54) METHOD OF ISOLATION OF HYALURONAN

(71) Applicant: New York University, New York, NY (US)

(72) Inventors: Mary K. Cowman, Mohegan Lake, NY (US); Fok Vun Chan, Salt Lake City, UT (US)

(21) Appl. No.: 17/819,680

(22) Filed: Aug. 15, 2022

Related U.S. Application Data
(60) Provisional application No. 63/234,611, filed on Aug. 18, 2021.

(51) Int. Cl. G01N 1/40; C08B 37/08

(52) U.S. Cl. CPC G01N 1/405; C08B 37/0072

(57) ABSTRACT

The present disclosure provides a facile method for selective isolation of hyaluronan (HA) from fluids and tissues by adsorption to a solid matrix. The method involves the use of specific solvent conditions and solid phase media favoring binding and subsequent elution of HA ranging in size from about 10 kDa to several MDa, while allowing separation of HA from other biological polyanions such as nucleic acids, sulfated glycosaminoglycans, chondroitin, and heparosan.

### CROSS REFERENCE TO RELATED APPLICATION

This application claims priority to U.S. Provisional Application No. 63/234,611, filed on Aug. 18, 2021, the disclosure of which is incorporated herein by reference.

### STATEMENT REGARDING FEDERALLY SPONSORED RESEARCH

This invention was made with government support under contract no. 1R43GM131444 awarded by the National Institutes of Health. The government has certain rights in the invention.

### FIELD OF DISCLOSURE

The present disclosure relates to a method for purifying hyaluronan from biological fluids, tissues, cultured cells, or other biological materials using solid phase adsorption.

### BACKGROUND OF THE DISCLOSURE AND DESCRIPTION OF RELATED ART

Hyaluronan (HA), also called hyaluronic acid, is a linear glycosaminoglycan polymer composed of repeating disaccharides of β-D-glucuronic acid and N-acetyl-β-D-glucosamine. It is a major component of the extracellular matrix in many vertebrate tissues. The molecular mass (M) of isolated HA is polydisperse, averaging approximately 2-6 million Daltons (2000-6000 kDa) in many healthy tissues, but ranging from about 10,000 kDa to small oligosaccharide fragments with M of a few kDa.

Both high and low M HA are considered to be involved in a variety of cell regulatory functions. Because the M distribution of HA is important in physiological and pathological processes, medical researchers need to be able to isolate and analyze intact HA molecules from a wide variety of biological fluids and tissues, as well as many types of cultured cells used to model the processes. It is desirable to isolate HA quantitatively and without degradation, preserving the entire range of M present in a given tissue at a given time.

The current state of the art in HA isolation is a complex and time-consuming process involving removal of proteins, nucleic acids, and sulfated glycosaminoglycans in multiple steps usually including toxic organic solvents, multiple enzymatic degradations, solvent changes and removal of low M contaminants by dialysis, concentration, additional precipitations, re-dissolution, etc. Most of the procedures employed today have never been validated for quantitative yield, and perhaps more importantly, for faithful maintenance of the original size distribution of the HA molecules present in the sample.

Tissues and fluids are often frozen or freeze-dried before being used. Prior to extracting HA, some tissues or biological fluids may be treated to reduce lipid content while inactivating hydrolytic enzymes. Chloroform and methanol or ethanol have been used, but also acetone and ether.

For isolation of HA from certain connective tissues such as rooster comb with high HA and low cellular content, HA and HA-protein complexes can be extracted with water (which may contain 5% chloroform) or dilute salt solutions. HA in biological fluids, including conditioned medium from cultured cells, is soluble, but may also have bound protein. Solid tissues may require disruption by mechanical or enzymatic methods before HA can be extracted.

Extracted HA can be collected by precipitation using cetyl pyridinium chloride (CPC) or similar detergents (e.g., CTAB), but these reagents can be difficult to remove from the final product. Most commonly, HA has been precipitated from salt solutions (e.g., calcium acetate or sodium acetate or sodium chloride) using final ethanol concentrations of about 75-80%, which is greater than the concentrations needed to precipitate sulfated glycosaminoglycans such as dermatan sulfate (ca. 18-25%), heparin or heparan sulfate (ca. 20-30%), or chondroitin sulfates (ca. 30-50%). Nucleic acids are also precipitated by lower ethanol concentrations (ca. 25%). However, the ethanol precipitation is usually not done in a stepwise manner, and proteins, nucleic acids, and sulfated glycosaminoglycans are not removed by a single precipitation step using 75-80% ethanol.

Proteins can be removed by precipitation with cold 5% trichloroacetic acid, or denatured and precipitated using chloroform, or chloroform with isoamyl alcohol, or phenol with chloroform and isoamyl alcohol. For most tissues, disruption using proteolytic enzymes has been widely adopted, allowing easier aqueous extraction of the HA and simultaneous removal of most protein.

In many current HA isolation protocols, complete removal of nucleic acids is commonly accomplished using enzymes such as DNase, RNase, or Benzonase®.

Final separation of HA from sulfated glycosaminoglycans is frequently accomplished using anion exchange chromatography, where HA can be separated from the more highly charged glycosaminoglycans, using stepwise or gradient elution with salt solutions of increasing concentration. Ion exchange chromatography does not remove unsulfated glycosaminoglycans such as chondroitin from HA. There have previously been no methods known to successfully separate chondroitin or heparosan from HA.

The above-described isolation procedures involve multiple enzymatic digestions, repeated precipitation, dialysis and concentration steps. The time needed for most accepted protocols is multiple days, and usually about one week. Even then, the HA can be accompanied by impurities, mainly enzyme-resistant proteins and chondroitin.

### SUMMARY OF THE DISCLOSURE

There continues to be a need in the field of HA purification for a faster and simpler method where yield could be high, where size and mass distribution is retained. Just as facile isolation of DNA and RNA revolutionized molecular biology, a similarly simple method for isolation of HA may have a significant impact on studies leading to improved understanding of cellular response to changes in the surrounding microenvironment of the extracellular matrix.

For DNA and RNA isolation, silica has been used as adsorbent. DNA and RNA can be adsorbed to silica in chaotropic solvents containing such agents as guanidinium isothiocyanate and guanidinium hydrochloride, sometimes with addition of a non-solvent like ethanol to increase adsorption. Therefore, considering that HA is also a polyanion, HA isolation was attempted using commercially available kits for DNA and RNA isolation. However, HA did not bind silica under the conditions in those kits. This disclosure provides a method by which HA can be selectively bound to a substrate like silica. The present method may be used to allow HA to be separated from contaminating nucleic acids and other glycosaminoglycans.

The present disclosure describes conditions and materials for selectively isolating HA from biological materials. The method comprises contacting a biological material or other composition comprising HA from which HA is to be isolated with a binding matrix, such as silica under high salt conditions such that HA is selectively adsorbed to the binding matrix. Once unbound materials are removed via washing, the bound HA may be eluted by contacting the bound HA with a solution, or series of solutions, that liberate the HA from the binding matrix. A method of the present disclosure does not require, and in embodiments, does not include time-consuming steps or hazardous materials, such as dialysis steps, repeated precipitation steps with alcohols, or use of organic materials such as chloroform and phenol to denature proteins. In embodiments, one or more dialysis steps may be included.

### BRIEF DESCRIPTION OF THE FIGURES AND TABLES

For a fuller understanding of the nature and objects of the disclosure, reference should be made to the following detailed description taken in conjunction with the accompanying figures.

FIG. 1. HA binds silica reversibly in concentrated NaCl solutions. Six identical HA samples consisting of a mixture of four HA standards (1700 kDa, 150 kDa, 50 kDa, 9 kDa, 0.5 μg each except 1 μg for 9 kDa HA) were loaded on six silica columns (140 μg silica each) at NaCl concentrations of 0-4 M. After binding HA, each silica column was washed in 5 mM Tris-0.5 mM EDTA (pH 7.1) containing 50% trifluoroethanol, then HA was eluted in a three step procedure using 1) 10 mM Tris-1 mM EDTA (pH 7.5), 2) PBS (pH 7.4), and 3) 0.4 M KOH. The six paired unbound and bound+eluted fractions were desalted, dried and dissolved in water. A) Polyacrylamide gel electrophoresis on 4-20% polyacrylamide. BPB=bromophenol blue tracking dye. B) HA concentration assayed by AlphaScreen.

FIG. 2. HA size distribution is maintained following adsorption to silica in 5 M NaCl and elution. A) 4-20% polyacrylamide gel image: lane 1, HA eluted after adsorption to silica in 5 M NaCl; lane 2: untreated control HA mixture. The HA mixtures contained 0.5 g each of 1700, 150, and 50 kDa HA, and 1 μg of 9 kDa HA. B) densitometric analysis of lanes 1 and 2, with relative mobility of 1.0 corresponding to the marker dye bromophenol blue. The profiles are offset vertically to facilitate comparison.

FIG. 3. HA can be separated from sulfated GAGs by selective adsorption to silica. Electrophoretic analysis on 4-20% polyacrylamide of pure GAG standards (Lanes 1-4), a mixture of the GAGs (Lane 5) and HA purified from the mixture by adsorption to silica in 5 M NaCl and elution using 10 mM Tris-1 mM EDTA (pH 7.5), PBS (pH 7.4), and 0.1 M NaOH (Lane 6). Lane 1: HA (top to bottom): 1700 kDa, 150 kDa, 50 kDa, 31 kDa, 1 μg each. Lane 2: Chondroitin sulfate, 2 μg. Lane 3: Heparan sulfate, 2 μg. Lane 4: Heparin, 1 μg.

FIG. 4. Polyacrylamide gel electrophoresis demonstrating HA purification from HEK293 cell conditioned medium spiked with standard HA samples and sulfated GAGs. All samples in lanes 7-10 were desalted on a ZebaSpin column, dried by centrifugal evaporation, and re-dissolved in water before analysis, with 80% of each sample loaded on the gel. Lane 1: Mixture of pure HA standards of differing sizes. From top to bottom: 1700 kDa, 150 kDa, 50 kDa, 31 kDa, 1 μg each. Lane 2: Chondroitin sulfate standard, 2 μg. Lane 3: Heparan sulfate standard, 2 μg. Lane 4: Heparin standard, 1 μg. Lane 5: Mixture of HA and sulfated GAG standards. Lane 6: empty. Lane 7: Conditioned medium, untreated, 250 μl original volume. Lane 8: Conditioned medium, 250 μl original volume, spiked with HA+sulfated GAG standards. Lane 9: Conditioned medium, 250 μl original volume, spiked with HA+sGAGs, then subjected to proteinase K digestion. Lane 10: Conditioned medium, 250 μl original volume, spiked with HA+sGAGs, then proteinase K digestion and purification of HA using adsorption to silica in 5 M NaCl and elution using 10 mM Tris-1 mM EDTA (pH 7.5), PBS (pH 7.4), and 0.4 M KOH.

FIG. 5. Polyacrylamide gel electrophoresis demonstrating HA purification from 100 μL human serum samples spiked with HA standards ranging in size from 9-1700 kDa. All samples in lanes 2-6 contained 100 μl original serum volume and spiked HA standards. For lanes 5 and 6, for the final silica step samples were brought to 5 M NaCl, then adsorbed to silica and eluted following the standard procedure. All samples in lanes 2-6 were desalted on a ZebaSpin column, dried by centrifugal evaporation, and re-dissolved in 10 μl water before electrophoretic analysis. Lane 1: Mixture of pure HA standards of differing sizes. From top to bottom: 1700 kDa, 150 kDa, 50 kDa, (0.5 μg each), and 9 kDa (1 μg). Lane 2: Untreated serum. Lane 3: Serum treated with Affi-Gel albumin affinity column. Lane 4: Serum treated with Affi-Gel and proteinase K. Lane 5: Serum treated with Affi-Gel, proteinase K, and silica. Lane 6: Serum treated with Affi-Gel and silica.

FIG. 6. HA can be separated from chondroitin (CH) and heparosan (HN) by salt concentration-specific adsorption to silica. A) 4-20% polyacrylamide gel electrophoretic characterization of polydisperse CH and nearly monodisperse HN samples, 1 μg each. B) Analysis of the unbound fraction of a GAG mixture of HA (5 μg)+HN (1 μg)+CH (1 μg) after loading on silica at the indicated NaCl concentrations shows that HN and CH are removed at lower NaCl concentration than HA. Six different silica columns were loaded at the indicated salt concentrations. C) Analysis of GAGs (mixed HA+HN+CH) retrieved after binding at the indicated NaCl concentrations shows that 2 M NaCl can be used to obtain (e.g., remove) CH and HN, but binding in 4 M NaCl allows all three types of unsulfated GAGs to be obtained.

FIG. 7. DNA can be removed from HA by adsorption to silica in 2 M NaCl. Electrophoretic analysis on 4-20% polyacrylamide of HA and DNA 100 bp ladder. Lane 1: HA (top to bottom: 150 kDa, 50 kDa) 1 μg each. Lane 2: DNA 100 bp ladder standard, 100-1517 bp, 3 μg. Lane 3: Mixture of HA+DNA standards before silica. Lane 4: Unbound sample from HA+DNA exposed to silica in 2 M NaCl, showing that most DNA was removed by adsorption to silica in 2 M NaCl, but HA was not removed.

FIG. 8. Molecular weight estimation of sulfated GAG (sGAG) samples by densitometry of PAGE gel stained with Stains-All. GAG standards of related structure were co-electrophoresed.

FIG. 9. Densitometric analysis of a 4-20% PAGE gel stained with Stains-All dye gives a linear response for a mixture (CS:HS:HP 2:2:1) of sulfated GAGs (sGAG), loaded from 0.1-3.0 μg per lane. (A) shows a densitometric scan, with subtraction of a blank lane to give corrected absorbance. (B) shows the relationship between corrected absorbance at the peak position (pixel 815 for this gel) for the stained band and the sGAG load for each lane.

FIG. 10. The failure of sGAGs to adsorb to silica in high salt solution was demonstrated by quantitative densitometry of a PAGE gel stained with Stains-All, for mixed GAG samples before and after exposure to the HA isolation procedure using silica. A mixture containing 2.4 μg of CS, HS, and HP in the ratio 2:2:1, and 2.4 μg HA showed removal of sGAG to an undetectable level. (A) shows densitometric scan of the sGAG region of the gel, with subtraction of an adjacent blank lane from each sample lane to give corrected absorbance. Four lanes contained equal loads of the original mixture, and four lanes contained quadruplicate samples independently treated to the silica protocol to isolate HA and remove sGAG. (B) shows corrected absorbance at the peak position (pixel 950 for this gel) for the stained sGAG band region before versus after the silica protocol. **** p<0.0001.

### DETAILED DESCRIPTION OF THE DISCLOSURE

Although claimed subject matter will be described in terms of certain examples/embodiments, other examples/embodiments, including examples/embodiments that do not provide all of the benefits and features set forth herein, are also within the scope of this disclosure. Various structural, logical, or process changes may be made without departing from the scope of the disclosure.

All ranges provided herein include all values that fall within the ranges to the tenth decimal place, unless indicated otherwise.

To provide a more concise description, some of the quantitative expressions given herein are not qualified with the term “about.” It is understood that, whether the term “about” is used explicitly or not, every quantity given herein is meant to refer to the actual given value, and it is also meant to refer to the approximation to such given value that would reasonably be inferred based on the ordinary skill in the art, including equivalents and approximations due to the experimental and/or measurement conditions for such given value. For example, about refers to +10%.

In an aspect, the present disclosure provides methods for separating (e.g., purifying) hyaluronan (HA). The HA can be purified from a sample isolated from biological fluids (e.g., conditioned media, serum, and the like), tissues, cells, or other biological media (all of which may be referred to as “biological material”) or from a mixture of materials that comprise HA. The method may be utilized to separate HA from other glycosaminoglycans (GAGs), nucleic acids, and proteolytic fragments. The method of the present disclosure utilizes solid phase adsorption.

As used throughout, the term “adsorbed” is used interchangeably with the term “bound.” Both terms indicate non-covalent binding of a material to a surface.

A method of the present disclosure avoids certain steps and materials utilized by previous methods. For example, a method of the present disclosure does not require, and in some embodiments, does not include one or more of the following: dialysis steps, repeated precipitation steps with alcohols, and use of organic materials such as chloroform and phenol to denature proteins. Currently used methods for purification of HA take a considerable amount of time, e.g., multiple days. A method of the present disclosure may be accomplished in less than 24 hours or less than 36 hours or 48 hours.

An advantage of some embodiments of the present disclosure is the ability to isolate HA from biological samples smaller than about 100 mg wet weight (wet weight) (e.g., sub-microgram quantities of HA from biological samples smaller than about 100 mg (wet weight).

The mixture of components from which HA may be separated may be referred to herein as a “sample”, which may be directly derived from a biological source or may comprise individual components which have been combined. The present disclosure provides a method for separating (e.g., isolating) HA from other components in the sample comprising contacting the sample with a binding matrix (e.g., silica). The sample may comprise one or more biological components (e.g., GAGs (unsulfated and sulfated GAGs), nucleic acids, and proteolytic fragments) and HA. The sample is contacted with a binding matrix in a binding solution; followed by washing the binding matrix (e.g., silica) with a solution to remove undesired materials (which may have previously been unbound or loosely bound to the binding matrix); and eluting the HA from the binding matrix (e.g., silica) with an elution solution (which may also be referred to as an “elution solvent” or “elution buffer”). The binding solution has an ionic character that causes adsorption of the HA onto the silica. Rinsing the binding matrix (e.g., silica) with the washing solution causes unbound materials, such as sulfated GAGs and proteins or proteolytic fragments, to be removed from the binding matrix (e.g., silica). Rinsing the binding matrix (e.g., silica) with elution solution causes adsorbed HA on the binding matrix (e.g., silica) to dissociate from the surface of the binding matrix and elute from the binding matrix (e.g., silica). The method may comprise one or more centrifugation steps. Filtration may also be facilitated by vacuum, gravity, by applying a positive pressure of a gas (e.g., an inert gas, such as, for example, argon, nitrogen, or the like), or by any combination of the foregoing. For example, prior to contacting with a binding matrix, protein components may be removed from the sample. In various examples, the method may avoid the use of a chaotropic agent. As used herein, “chaotropic agents” are agents that are used to disrupt the structure of water and denature proteins or nucleic acids. Examples of chaotropic agents include guanidinium hydrochloride and guanidinium isothiocyanate. In other examples, the method may avoid the use of phenol and chloroform. Additionally, the method may avoid using nucleases, such as, for example, DNase, RNase, Benzonase©, papain, or the like, or a combination thereof.

The method may further comprise a plurality of binding and elution steps. The additional binding and elution steps may remove additional undesired biological components (e.g., chondroitin, heparosan, nucleic acids) from the desired product (HA). The additional binding solution comprises a salt at a lower concentration than that used for binding HA. In embodiments, the additional binding solution is an aqueous solution with, for example, about 2 M NaCl, which may be used prior to or after contact with about 4-5 M NaCl. This additional binding step may be referred to as a “polishing step.” In embodiments, the isolation method includes a first binding step at a lower binding salt concentration, followed by a second binding step at a higher salt concentration. In an embodiment, the first binding step uses a first binding solution which is an aqueous solution of 2 M NaCl, and the second binding step uses a second binding solution which is an aqueous solution of 4-5 M NaCl.

HA of various lengths and molecular weights may be purified and separated from biological materials. The HA may be from biological fluids, tissues, cells, and/or the like. Isolation from these materials is described herein. The HA may have a molecular weight ranging from small fragments to large polymers. In various examples, the weight-average molecular weight of HA that may be isolated by the method is 4 to 10,000 kDa, including all 0.1 Da values and ranges therebetween. The samples from which HA can be isolated include, but are not limited to, serum, urine, lymphatic fluid, cerebrospinal fluid (CSF), saliva, sputum, bronchoalveolar lavage fluid, plasma or conditioned medium from cells in culture or solid tissue samples and/or extracts thereof, cultured cells, or cultured organoids.

It was surprisingly found that silica works as a desirable binding matrix that preferentially binds HA over sulfated GAGs and proteins under high salt conditions, and that can be used to separate HA from other unsulfated GAGs and nucleic acids by proper choice of binding solution ionic strength. Hydroxyapatite is not suitable to isolate HA. HA does not bind endotoxin removal columns. While HA does bind to agarose with polylysine, it is difficult to bind all sizes equally and then subsequently elute from the agarose. Silica allows for binding of HA in the presence of a neutral salt (e.g., NaCl or NaI), but sulfated GAGs do not bind. In various examples, the silica used in a method of the present disclosure is amorphous precipitated silica gel particles. The silica may be natural crystalline silica or microcrystalline silica, or amorphous silica gel formed by a chemical manufacturing process. The silica may be borosilicate or soda lime glass. The silica may be in the form of particles or coatings on membranes, beads, or the like. The particles may be irregularly shaped or spherical. Channels penetrating solid silica, or silica coated channels in other materials/devices (e.g., a microfluidic device) are also suitable for use in a method of the present disclosure.

Particles of varying size can be used for HA isolation by adsorption. The characteristic solvent conditions for binding and elution of HA, as well as the binding capacity, can be affected by the particle size and correlated surface area per unit volume. A narrow particle size distribution provides well-controlled binding and elution properties, optimum uniformity in column packing to avoid channel formation, and also avoids potential filter clogging by a small fraction of fine particles.

The silica may have various dimensions. The silica particles may have a diameter of 0.5-10 m, including every 0.1 μm value and range therebetween, with 80% of the particles being 1-5 μm in diameter. Without intending to be bound by any particular theory, it is considered that larger particles may also be used, but will have reduced surface area and binding capacity per unit weight. If to be separated by filtration, the particle diameter must be larger than the pore size of the filtration device; for example, greater than the 20 μm pore size of a polyethylene filter. For such an example, the average size is 40-63 m in diameter, with 90% of the particles within the stated size range. The silica may be loose silica or disposed on a surface or bound to a surface.

The average pore size for a preparation of amorphous silica gel particles may depend on the manufacture process. Pore size (porosity) increases the total surface area of particles, and thus the binding capacity. It can also determine the accessibility of the intra-particle surface area to molecules of differing sizes. For example, the pore size is 55-65 Å (e.g., 55, 56, 57, 58, 59, 60, 61, 62, 63, 64, or 65 Å), which restricts HA penetration into the particles and favors adsorption primarily to the particle outer surface, facilitating its elution in the following steps. Larger pore sizes up to 1000 Å, which increase HA penetration, may also be employed, with appropriate consideration for incubation time and flow rate optimization for complete elution.

In various examples, the silica may be 40-63 μm diameter, 60 Å pore size, and a surface area averaging 484 m²/g.

It was found that HA has desirable adsorption properties with silica under high salt conditions. For example, pure HA (e.g., HA with a weight-average molecular weight of 4 kDa to 10,000 kDa) binds to silica at room temperature in unbuffered (e.g., pH<7) solutions that have high ionic strength. For example, it was found that at least 98% of HA having a weight-average molecular weight of 9 to 1700 kDa applied in 5 M NaCl binds at loads of 1-10 μg HA per 140 μg silica (when used in a minispin column format). HA binding may be size independent in concentrations above about 4 M NaCl (e.g., about 4-5 M or 4-6 M), whereas in 2.5-3 M NaCl low molecular weight HA (e.g., less than 50 kDa) may incompletely bind, and binding for HA of all molecular weight is weak in solutions of <2 M NaCl.

The binding matrix may be disposed on any surface of a device to achieve adsorption of materials. For example, the silica may be disposed in a centrifuge tube (e.g., microcentrifuge tube), a filter, a frit, chromatography column, multi-welled plate, microfluidic device, or a spin column (e.g., mini spin column). Other similar articles with suitable surfaces are known in the art.

The binding solutions may be aqueous ionic solutions and a pH of 5.5-7.5, including all 0.01 pH values and ranges therebetween. In various embodiments, the binding solutions may be high salt conditions. The binding solution comprises a salt (e.g., a sodium salt). Examples of salts include, but are not limited to, salts used in DNA extraction, ammonium acetate (NH₄OAc), MgCl₂, CaCl₂), NaCl, NaI, and the like. Potassium salts (e.g., KCl and KI) and trivalent cationic salts (e.g., Tb³⁺, such as, for example, TbCl₃) are also envisioned. The concentration of the salt may be from 2 M up to the solubility limit of the salt in the selected media (e.g., water), including every 0.1 M value and range therebetween. For example, when the salt is NaCl, the concentration is 4-5 M or 2.5 M or 5 M. For example, when the salt is NaI, the concentration is 3-5 M or 5 M. For example, when the salt is NH₄OAc, the concentration is 5 M.

The washing solutions may comprise a solution in which the HA is not sufficiently soluble to allow release from the binding matrix, such as solutions containing a suitable mixture of an alcohol, a buffer salt, and, optionally, a chelation agent. Examples of alcohols include trifluoroethanol, isopropanol, ethanol, and the like. Examples of chelation agents include EDTA and the like. Examples of buffer salts include Tris, phosphate buffering salts (such as, for example phosphate buffered saline), and the like. For example, the washing solution comprises trifluoroethanol, EDTA, and Tris. Various concentrations of the components may be used. For example, the concentration of trifluoroethanol is 50% by volume, the concentration of EDTA is 0.5 mM, the concentration of Tris is 5 mM, and the pH is less than 7.5 (e.g., 7.1). Replacement of 50% trifluoroethanol with 75% ethanol in the same Tris-EDTA buffer can be used but there is some loss of the lowest molecular mass HA (<50 kDa). The washing may be done at various temperatures and for various lengths of time. For example, the binding matrix may be washed for around 20 minutes at room temperature.

The elution solutions may comprise a chelation agent and/or a buffer salt and/or a base. In various examples, the chelation agent is optional. In other embodiments, the elution solution comprises a buffer salt. In other embodiments, an elution solution comprises a strong base. Non-limiting examples of chelation agents include EDTA and the like. Non-limiting examples of buffer salts include Tris, phosphate buffering salts (such as, for example phosphate buffered saline), and the like. Non-limiting examples of strong bases include hydroxide bases, such as NaOH, KOH, NH₄OH, and the like. For example, the elution solution comprises EDTA and Tris. Various concentrations of the components may be used. For example, the concentration of EDTA is 1 mM, the concentration of Tris is 10 mM, and the pH is 7.5. In various other embodiments, the elution solution comprises PBS at pH 7.4. In various other embodiments, the elution solution comprises 0.4 M KOH or 0.1 M NaOH.

In embodiments, there is only one elution step. For example, the elution step may be accomplished by contacting the silica with a strong base. The contacting may be performed at an elevated temperature (e.g., around 37° C.).

In various examples, a plurality of elution solutions are used in sequence, where each solution is the same or different. For example, the first elution solution comprises Tris and EDTA, the second elution solution comprises PBS, and the third elution solution comprises KOH. Each elution solution may be used a various number of times, at various temperatures, and for various lengths of the time. For example, the first elution solution may be used twice, followed by the second elution solution, followed by the third elution solution. The third elution solution may be used overnight at 4° C. or, alternatively, may be at room temperature.

The steps of the method described in the various embodiments and examples disclosed herein are sufficient to carry out the methods of the present disclosure. Thus, in an embodiment, the method consists essentially of a combination of the steps of the methods disclosed herein. In another embodiment, the method consists of such steps.

In an aspect, the present disclosure provides kits. A kit of the present disclosure provides the various components used in a method of the present disclosure.

A kit may comprise various components. For example, the kit comprises a binding matrix (e.g., silica), a binding solution, a washing solution, and an elution solution. These components are described herein.

The following are some embodiments of the present disclosure.

In an embodiment, the disclosure provides a method of separating hyaluronan (HA) from a biological fluid or solid sample comprising the steps of contacting the sample with silica in a binding solution, wherein the binding solution is an aqueous solution comprising a salt at a concentration greater than 2 M, and wherein the HA binds to the silica; washing the silica with a washing solution to remove unbound materials; and eluting the bound HA from the silica with an elution solution, wherein the concentration of sulfated glycosaminoglycans of the eluted HA sample is at least 90% less than the concentration of the sulfated glycosaminoglycans of the sample prior to contacting the sample with the silica.

The sample may be a serum, urine, lymphatic fluid, cerebrospinal fluid (CSF), saliva, sputum, bronchoalveolar lavage fluid, or plasma.

The sample may also be conditioned medium from cells in culture or solid tissue samples and/or extracts thereof, cultured cells, or cultured organoids.

According to the present disclosure the salt of the binding solution can be NaCl aqueous solution or NaI aqueous solution.

In an embodiment, the present disclosure does not include use of the chaotropic agents guanidinium hydrochloride and guanidinium isothiocyanate.

In another embodiment, the present disclosure does not include the removal of protein using a solvent or solution containing phenol or chloroform.

The present disclosure includes where the HA has a mass from 4 to 10,000 kDa.

In an embodiment, the method described does not include use of a nuclease, including DNase, RNase, or Benzonase®.

The method of this disclosure can include silica that is microcrystalline or in amorphous particles. The silica can also be disposed or bound on a portion of a surface of a microcentrifuge tube, a microfluidics device, a bead, a multi-well plate, or a mini spin column.

In an embodiment where the salt is an aqueous NaCl, the concentration of the solution can be greater than or equal to 4-5.5 M NaCl (e.g., 4.0, 4.1, 4.2, 4.3, 4.4, 4.5, 4.6, 4.7, 4.8, 4.9, 5.0, 5.1, 5.2, 5.3, 5.4, or 5.5 M). In another embodiment, the concentration can be greater than or equal to 2.5 M NaCl (e.g., greater than or equal to 3 M NaCl).

In an embodiment where the salt is an aqueous NaI, the concentration of the solution can be greater than or equal to 3 M NaI.

The washing solution of the described method can include a washing solution which is an aqueous solution comprising a buffering system (e.g., a weak buffering system, such as, for example, 5 mM Tris and 0.5 mM EDTA), with a pH of about 7, and an alcohol. In an embodiment, the washing solution can comprise 75-80% by volume ethanol or at least 75% by volume ethanol. In various embodiments, the washing solution can comprise 50% by volume trifluoroethanol or at least 50% by volume trifluoroethanol. In various embodiments, the washing solution can comprise 50-75% by volume isopropanol or at least 50% by volume isopropanol.

The elution solution can be an aqueous solution comprising 10 mM Tris and 1 mM EDTA, with a pH of 7-8.

In some embodiments, the eluting step can be followed by a second eluting step at a temperature of 4° C. to room temperature. There may also be a third eluting step, which may be 20 minutes in duration. The third eluting step may also be overnight in duration. This third eluting step may be performed at a temperature of 4° C. to room temperature. The third eluting step may comprise adding a strong base, such as a hydroxide base.

In an embodiment, the eluting is a single step comprising contacting the washed silica with a strong base, such as NaOH or KOH. The eluting step may also be performed at 37° C.

A kit used for isolating HA from biological fluids and/or tissues, according to the present disclosure, can comprise silica, a binding solution of either aqueous NaCl or aqueous NaI, a washing solution, and an elution solution. In an alternate embodiment, the kit can include dry NaCl or dry NaI, which can be dissolved in water or a similar solvent, or in a fluid biological sample. In the contemplated embodiments, the dissolved or aqueous NaCl generates a concentration in solution that is greater than or equal to 4 M NaCl. In another embodiment, the dissolved or aqueous NaCl generates a concentration in solution that is greater than or equal to 2.5 M. In another embodiment, the dissolved or aqueous NaI generates a concentration in solution that is greater than or equal to 5M NaI.

The binding solution can have a pH of 5.5-7.5, including all 0.1 pH values and ranges therebetween (e.g., 5.5, 5.6, 5.7, 5.8, 5.9, 6.0, 6.1, 6.2, 6.3, 6.4, 6.5, 6.7, 6.8, 6.9, 7.0, 7.1, 7.2, 7.3, 7.4, 7.5).

The washing solution can be an aqueous solution comprising 5 mM Tris and 0.5 mM EDTA, and 75-80% by volume ethanol or 50% by volume trifluoroethanol or 50-75% by volume isopropanol.

The elution solution may be an aqueous solution comprising a strong base. In some embodiments the strong base is either NaOH or KOH.

The following example is presented to illustrate the present disclosure. It is not intended to be limiting in any manner.

### EXAMPLE

The following example provides a description of a method of the present disclosure.

Materials and Methods

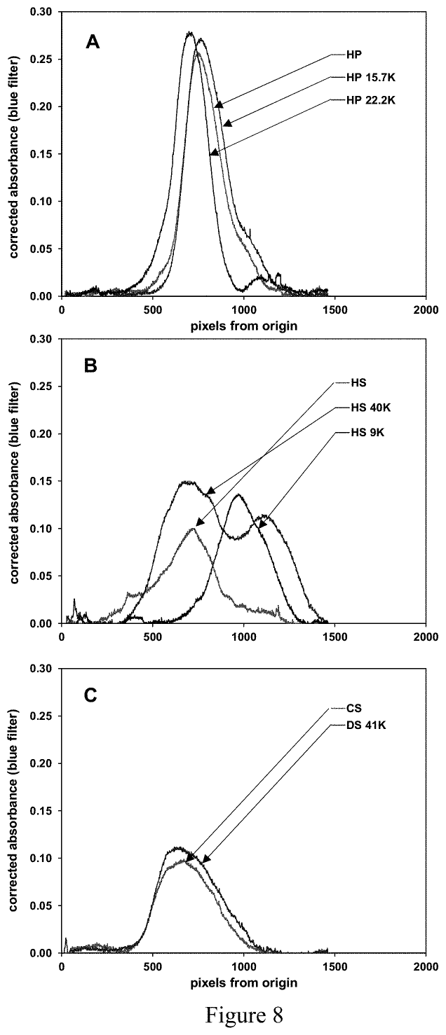

Chemicals: Silica was obtained as amorphous precipitated silica gel particles, 40-63 μm diameter, 60 Å pore size, surface area averaging 484 m²/g (Silicycle #R10030B). Sigma silica (#S5631) fine particles derived from naturally occurring microcrystalline silica ground to a powder, with diameter 0.5-10 μm (80% with diameter 1-5 μm) were also used (may be used in bulk separation by centrifugation but not suitable for use on a spin column with a 20 μm average pore size filter). HA samples were HA1700 kDa (Lifecore Biomedical, LLC, Chaska Minn.), SelectHA 31 kDa, 50 kDa, 150 kDa (Hyalose LLC, Austin, Tex., and Echelon Biosciences, Salt Lake City, Utah), and HA 9 kDa, a low molecular mass HA sample containing chains 19-25 disaccharides in length (8-10 kDa) prepared as known in the art. Sulfated glycosaminoglycans were chondroitin sulfate (Calbiochem #230699) (average M approximately 40 kDa), heparin (Sigma #H4784)(average M approximately 16 kDa), and heparan sulfate (Sigma #H7640)(average M approximately 40 kDa). The average M for each sulfated GAG sample was estimated by co-electrophoresis with known M standards (FIG. 8). Unsulfated glycosaminoglycans chondroitin (polydisperse, mainly 100-200 kDa, from bacterial fermentation) and heparosan (quasi-monodisperse, approximately 100 kDa, from chemoenzymatic synthesis) were, provided by Paul DeAngelis, University of Oklahoma Health Sciences Center. Nucleic acid samples were DNA restriction fragments, 100 bp ladder 100-1517 bp (New England Biolabs #N3231S) and ssRNA ladder containing RNA of 500-9000 bases (New England Biolabs #0362S). Protease was Proteinase K (Sigma #3115887001, 18.5 mg/ml in 10 mM Tris pH 7.5, stabilized with calcium acetate). Ethanol, 200 Proof, ACS Certified, was from Sigma Aldrich. Trifluoroethanol was from Chem-Impex Intl., #04832. Phosphate-buffered saline (PBS, 0.01 M phosphate, 0.138 M NaCl, 0.0027 M KCl, pH 7.4) was from Sigma Chemical, #P3813, and was sterile filtered using a Corning 430769, 0.22 um CA Sterilizing, low protein binding filter system. All other chemicals were reagent grade. Deionized water, 0.2 μm filtered, was from a MilliQ water purification system.

Biological fluids: Conditioned medium was from HEK293 cells (ATCC), grown and passaged in DMEM containing 10% FBS and 1% penicillin-streptomycin. Human type AB serum (sterile and HCV, HIV, HBsAG free) was from MP Biomedical, #092931949.

Devices and kits: Mini Spin Columns, 0.7 mL bed volume with a 20 μm pore polyethylene filter, were from BioVision (#6572). Zeba Spin desalting columns, 2 mL, 7K MWCO, were from Life Technologies (#89890). Aurum Affi-Gel Blue mini columns were from Bio-Rad Laboratories (#7326708). DNA and RNA isolation kits were PureLink Viral RNA/DNA mini kit (Thermo Fisher #12280050), MagMax 96 DNA Multi-Sample Kit (Thermo Fisher #4413021), HighPure PCR Template Preparation Kit (Roche #11796828001), MagnaPure LC DNA Isolation Kit (Roche Diagnostics #03003990001), RNeasy kit (Qiagen #74004). High capacity endotoxin removal columns were from ThermoFisher Pierce (#88274). Poly-L-lysine-Separopore 4B-CL (polylysine-agarose) #20181075-3 was from Bioworld (Dublin, Ohio). Polyacrylamide gels for electrophoresis were Novex 4-20% polyacrylamide 12-well gels from Life Technologies (#EC62252BOX). Other small equipment used included Thermo Scientific Sorvall Legend Micro 21 microcentrifuge; SCILOGEX SCI-T6-S, tube roller (½ max speed=40 rpm); Thermo Scientific Savant DNA 130 Vacuum Concentrator System (Cat. #13 875 331).

Isolation Procedure.

Pretreatment of Samples

HA-containing samples may be processed to remove the majority of proteins before the silica isolation step.

Pretreatment of conditioned medium. To provide visual validation of HA isolation without degradation, a duplicate sample of the conditioned medium sample may be spiked with a mixture of GAGs. Per 240 μL of conditioned medium, (all control GAG solutions were 1 μg/L in water) 1 μg HA 31 kDa+1 μg HA 50 kDa+1 μg HA 150 kDa+1p g HA 1.7 MDa+2 μg Chondroitin Sulfate+2 μg Heparan Sulfate+1 μg Heparin+1 μL filtered diH₂O=10 μL were added. To digest proteins in a 250 μL sample, 10 μL proteinase K solution containing 185 μg enzyme were added and the sample was incubated at 60° C. for 3 h. It was then boiled for 15 min, cooled, and clarified by centrifugation through an empty spin column at 1500× g for 5 min. The sample was weighed to determine volume, and dry NaCl was added to 5 M final concentration.

Pretreatment of serum. To provide visual validation of HA isolation without degradation, a duplicate sample of the conditioned medium sample may be spiked with HA. Per 100 μL of serum, (all control HA solutions were 1 μg/L in water) 1 μg HA 9 kDa+0.5 μg HA 50 kDa+0.5 μg HA 150 kDa+0.5 μg HA 1.7 MDa+7.5 μL filtered diH₂O=10 μl was added. This was mixed with 300 μL of 20 mM sodium phosphate buffer pH 7.0 (=dilute phosphate buffer). Aurum Affi-Gel Blue mini spin column prewashed with dilute phosphate buffer was prepared. The spin columns contained 0.45 mL of crosslinked agarose with covalently attached Cibacron Blue F3GA dye. Each column was found to bind up to about 5 mg albumin. 400 μL of diluted serum was loaded on a column, allowed to drain by gravity into a clean 1.5 mL microcentrifuge tube for 15 min, then the unbound solution was collected by centrifugation at 10,000×g for 20 s, and repeated with an additional 400 μL of dilute phosphate buffer to wash the column without waiting for a gravity flow elution step. The two unbound solutions were combined. It is possible to isolate HA directly from this sample by adding dry NaCl to make the solution 5 M, then adsorbing to silica for the isolation steps described below. Because the remaining protein content can partially block HA access to the silica surface, it is preferable to digest protein first. The sample was solvent exchanged to 0.1 M NaCl using a ZebaSpin column pre-equilibrated in that solvent, then treated with 40 μL proteinase K for the 800 μL sample, at 60° C. for 60 min. It was then boiled for 15 min, cooled, and clarified by centrifugation through an empty spin column at 1500× g for 5 min. The sample was weighed to determine volume, and dry NaCl was added to achieve a final concentration of 5 M.

HA adsorption and elution from silica. All reagents were used at room temperature, unless noted otherwise. 10% silica suspension in water was prepared, washed twice with centrifugation at 400×g for 5 min to remove fine particles. It was stored at room temperature, 0.05% sodium azide was added if it was stored for longer than two weeks. It was re-suspended by brief vortexing and placed on a roller for 10 min prior to use. An empty mini spin column (e.g., with 700 μL bed volume and 20 μm pore size polyethylene support) was prepared. The screw cap and fixed plug of the spin column were removed and saved. The spin column was placed into a 1.5-2.0 mL centrifuge tube. 700 μL of the 10% silica was transferred to the column. It was centrifuged at 1500×g for 5 min. The flow through water was discarded. An additional 700 μL of 10% silica was added and the previous steps were repeated. The bottom plug on the spin column was replaced. 240 μL 5 M NaCl was added and the tube closed with the screw cap top. It was vortexed for 10 seconds to mix. (This was a pre-equilibration step.) The bottom plug was removed and saved and the mini spin column was placed back into a centrifuge tube. The screw cap was loosened and the sample was centrifuged at 1500×g for 5 minutes. The bottom plug was replaced.

Load sample: ca. 240 μL sample was added in 5 M NaCl, the screw cap was replaced, and the spin column was vortexed for 10 s. It was incubated at room temperature for 20 min on horizontal roller. The bottom plug was removed, the screw cap was loosened, and the spin column was placed into a clean 1.5 mL centrifuge tube. It was centrifuged at 1500×g for 5 min to collect the first unbound fraction. The bottom plug was replaced on the mini spin column. The screw cap was removed and 240 μL 5 M NaCl was added. The screw cap was replaced and the spin column was vortexed for 10 s to mix. It was incubated for 20 min on a roller, and centrifuged at 1500×g for 5 min to collect a second unbound fraction. The unbound samples may be saved if isolation of sulfated GAGs is desired.

Wash: Washing was achieved by following the same steps, including brief vortex, 20 min incubation with rolling, and centrifugation to wash the silica twice with 240 L of 50% (v/v) trifluoroethanol in 5 mM Tris, 0.5 mM EDTA, pH 7.1.

Elute HA: Elution of HA was achieved by following the same mixing, incubation, and centrifugation protocols, to elute HA using three sequential steps. Elution buffer 1 was 240 μL of 10 mM Tris, 1 mM EDTA, pH 7.5. This step may be preferably done twice. Elution buffer 2 was 240 μL of PBS, pH 7.4. Elution buffer 3: 240 μL of 0.4 M KOH (This step may be most efficient with an overnight incubation at 4° C., but a 20 min room temperature incubation eluted most HA). The KOH extract was neutralized using 96 μL 1 M HCl or 96 μL 1 M CH₃COOH. The three eluted solutions were pooled and desalted using Zeba Spin desalting columns. If desired, samples may be dried on a centrifugal evaporator using heat up to 60° C. Samples may be re-dissolved in filtered deionized water. The buffering capacity of the CH₃COOH assists in bringing the pH of the solution to about pH 5.

Analytical methods: HA quantification was performed using an HA-specific AlphaScreen assay. Gel electrophoresis was performed on 4-20% polyacrylamide in Tris-borate-EDTA (TBE) buffer, using samples containing ca. 1-10 μg GAG in 10 μL water, mixed with 2 μL 0.03% bromophenol blue, 2 M sucrose in TBE. Gels were electrophoresed at 400 V for 22 min, stained with 0.005% Stains-All in 50% ethanol for 90 min, and de-stained in 10% ethanol for 10 min. Gels were scanned in grayscale using a red filter on a calibrated ImageScanner III with LabScan v.6, and color images were obtained using Epson scan software. Grayscale image files (16 bit) were densitometrically analyzed using ImageQuant TL 8.2 software (Cytiva).

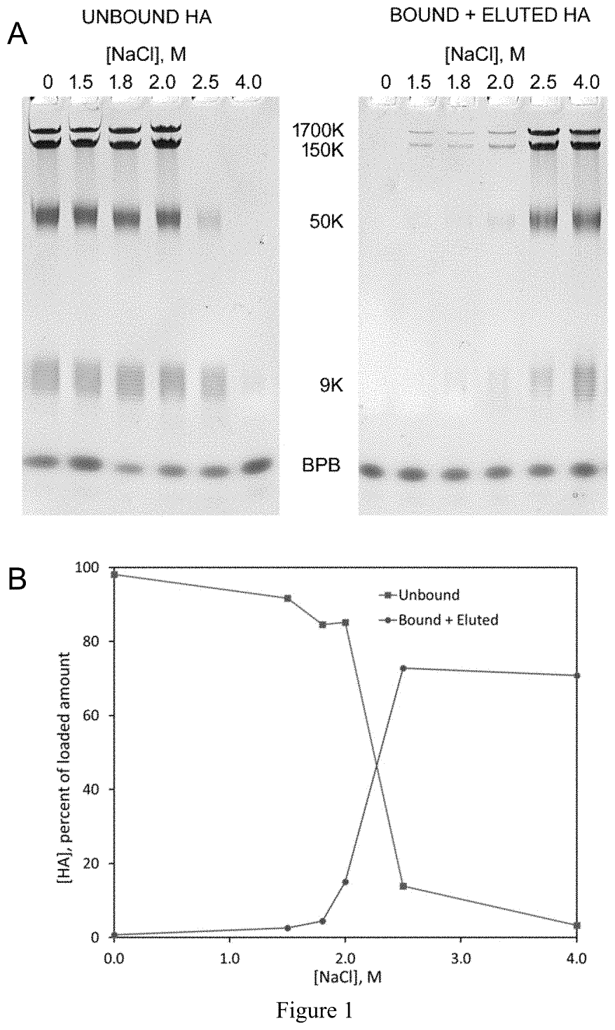

HA can be reversibly adsorbed to silica in concentrated NaCl solutions. Pure HA, ranging in size from 9 to 1700 kDa, was tested for binding to amorphous silica particles at room temperature in unbuffered (pH<7) NaCl solutions of high ionic strength (FIG. 1). Silica can be used as a simple additive, sedimented in a microcentrifuge tube to separate it from the unbound species left in solution, or it can be used in a mini spin column with a porous disk support to allow flow through. The supporting disk pore size should be smaller than the silica particle size (e.g., a spin column with a 20 μm pore polyethylene filter for 40-63 μm silica particles was employed). At least 98% of HA (9-1700 kDa) applied in 5 M NaCl is bound at loads of 1-10 μg HA per 140 μg of silica in a mini spin column format. HA binding is size-independent in 4-6 M NaCl, whereas in 2.5-3 M NaCl low M HA is incompletely bound, and binding for all sizes of HA is weak in <2 M NaCl. The preferred pH of the solution is pH 5.5-7.0, to reduce deprotonation of silanol groups and minimize repulsion between silica and polyanionic HA. (In unbuffered aqueous solutions, absorption of CO₂ from the air leads to formation of H₂CO₃, dissociating to H⁺ and HCO₃⁻, such that the solution pH tends toward a pH of ca. 5.5-6.0 over time.)

HA also binds to powdered silica in 3-5 M NaI solutions with similar M dependence. HA of all sizes binds weakly to silica in 5 M ammonium acetate. No HA binding to silica was observed in 6 M GuHCl (pH 3-5.5). No binding of HA to the powdered silica or silica-based membranes or fibers was observed in any tested commercial kit for DNA or RNA isolation using chaotropic GuSCN or GuHCl solutions for the binding step, in the presence or absence of added ethanol.

Other non-silica media were tested for HA binding and release. HA does not bind to endotoxin removal columns containing ε-poly-L-lysine-modified cellulose beads, in water or in phosphate buffered saline (PBS) at 25-100% strength. HA will bind poly-L-lysine-modified agarose in 10-50% strength PBS, but the binding is strongly M dependent (preferentially binding high M HA) and difficult to release.

Washing silica-bound HA to remove salts and contaminants can be accomplished at room temperature with a low ionic strength solution such as 5 mM Tris-0.5 mM EDTA at pH 7.1, containing 50% trifluoroethanol or 75-80% ethanol. Lower ethanol or trifluoroethanol concentration results in release of HA during the washing step.

Elution of HA of low to moderate M (up to ca. 150 kDa) from silica can be effected at room temperature using low ionic strength 10 mM Tris-1 mM EDTA buffer at a slightly higher pH of 7.5, followed by a second elution step using PBS at pH 7.4. Elution of high M HA may be incomplete after the first two steps, but can be achieved by a third overnight step using a basic solution such as 0.1-0.4 M NaOH or KOH, preferably at 4° C. No degradation of HA during binding or elution at room temperature or at 4° C. was observed, and the final yield of HA eluted after binding in 2.5-4 M NaCl was over 70% (FIG. 1).

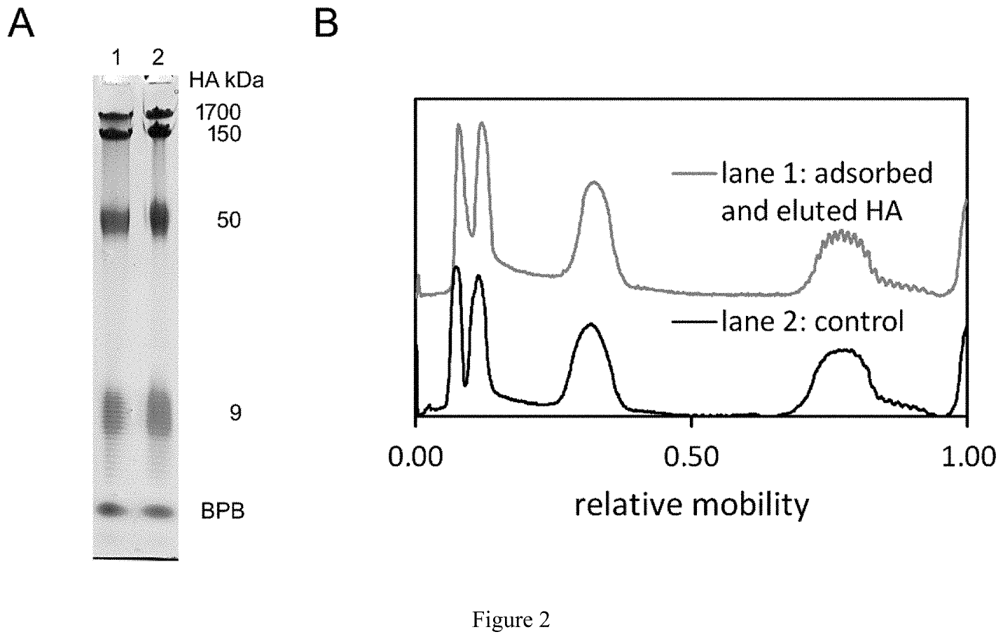

The molecular weight distribution of an HA sample mixture loaded on silica in 5 M NaCl and then eluted by the three-step procedure was quantitatively compared with that of the untreated control HA mixture. Densitometric analysis of the stained PAGE gel showed that the eluted HA profile closely resembled that of the original sample (FIG. 2).

HA can be Separated from Sulfated GAGs by Selective Adsorption to Silica.

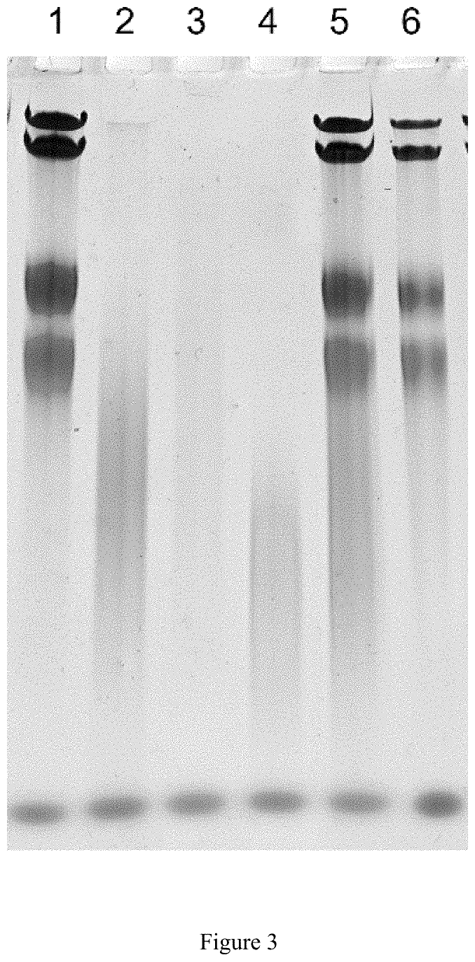

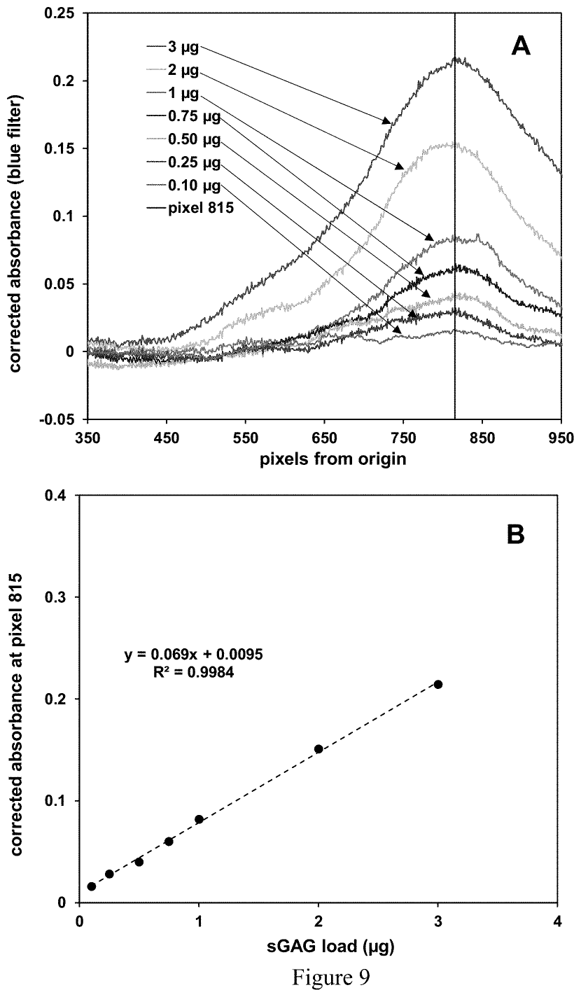

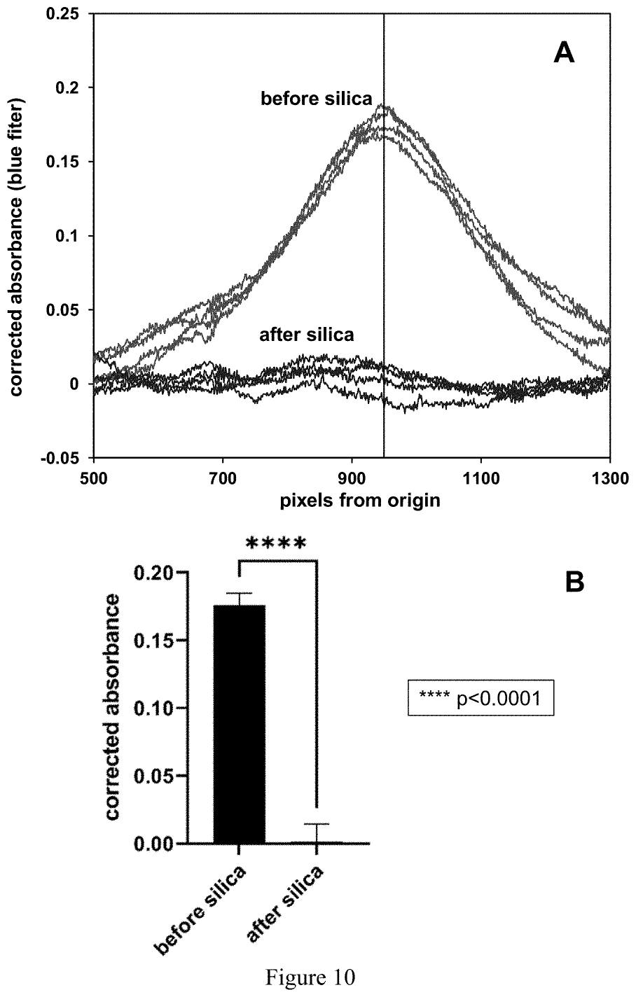

A mixture of pure HA and sulfated GAGs can be fractionated by adsorption to silica. Binding of chondroitin sulfate (CS), heparan sulfate (HS), and heparin (HP) to silica has not been detected at any NaCl concentration from 2-5 M. FIG. 3 shows that HA binding to silica in 5 M NaCl allows it to be separated from sulfated GAGs. Additional supporting data provided as FIGS. 9 and 10 show that densitometric analysis can be used to establish the lack of significant sulfated GAG contamination.

Because RNA binding to silica can be enhanced by addition of ethanol, GAG binding to silica was tested in 2.5 M NaCl containing 10-30% ethanol, but found no HA or sulfated GAGs bound to silica in those conditions. Other solvents were tested to seek conditions under which sulfated GAGs could bind silica, but none have been identified.

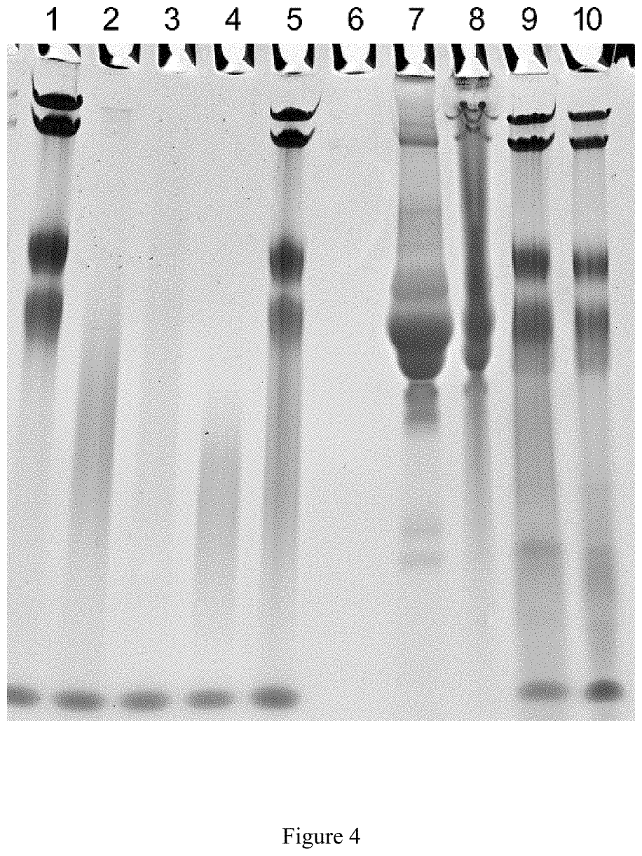

HA isolation from conditioned medium of cultured cells. HA spiked (with sulfated GAGs) into conditioned medium obtained from HEK293 cells can be isolated by proteolytic digestion, which leaves the GAGs intact, followed by adsorption to silica in 5 M NaCl to obtain purified HA (FIG. 4) (HA can also be purified from conditioned medium without protease treatment, but the yield is reduced). Note that the HA bands retain their nearly monodisperse sizes and are not degraded by the isolation procedure. There is a low degree of contamination of the HA by an unidentified fast-migrating blue-staining species. That species was tentatively ascribed to a protein that is incompletely degraded by proteinase K and that binds silica.

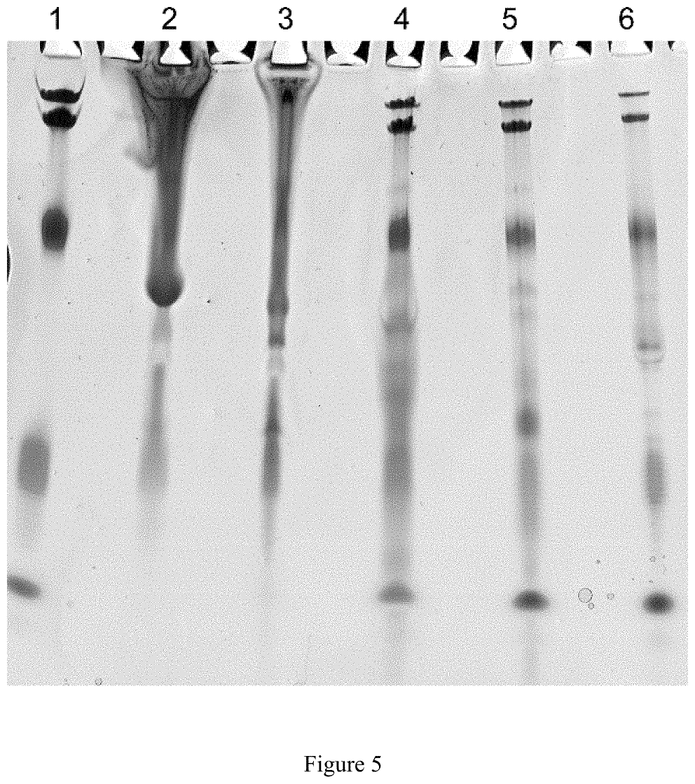

HA isolation from human serum. HA spiked into human serum can be isolated using silica adsorption, after removal of most protein using an albumin affinity column, with or without subsequent proteolytic digestion (FIG. 5). Note that the HA bands retain their nearly monodisperse sizes and are not degraded by the isolation procedures. Because the high albumin concentration in serum can reduce HA binding to silica, an affinity column containing the dye Cibacron Blue was employed to reduce the protein content (compare lanes 2 and 3 in FIG. 5). Following serum albumin removal, HA can be isolated directly using silica adsorption (lane 6), but with reduced yield, as a result of remaining protein interfering with HA adsorption. Higher yield of HA is obtained by using proteinase K treatment after the albumin removal (lane 4), then followed by silica adsorption and elution (lane 5). Comparing lanes 5 and 6 (with or without proteinase K treatment before silica), the yield of HA is greater after proteinase K (lane 5), but a fast-moving blue band is again observed as a contaminant in proteinase K-treated samples. Without proteinase K (lane 6), there is a contaminant band moving approximately halfway down the gel, as had been seen in conditioned medium.

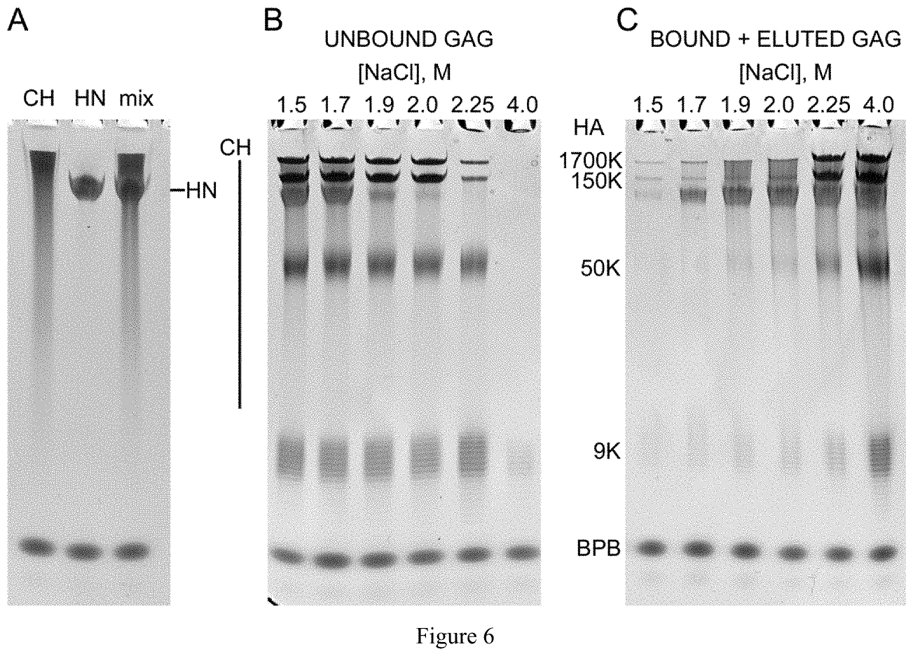

HA can be separated from other unsulfated GAGs by choice of salt concentration for adsorption to silica. Unsulfated GAGs chondroitin and heparosan were found to bind silica in 1.7-4 M NaCl. Because HA binds silica less well at low salt concentrations, chondroitin and heparosan can be separated from HA using adsorption in 2 M NaCl (FIG. 6). For routine HA isolation from biological samples with low chondroitin or heparosan content, a pretreatment or cleanup step using 2 M NaCl binding may be unnecessary.

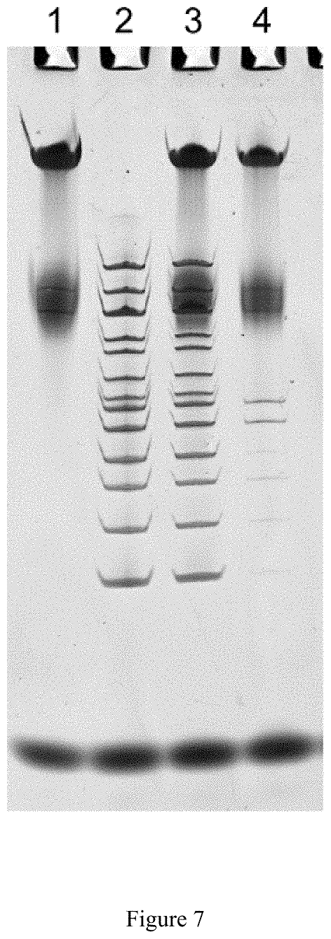

HA can be separated from DNA and RNA by choice of salt concentration for adsorption to silica. DNA and RNA are well known to bind silica in solutions of chaotropic salts like GuHCl and GuSCN. The adsorption of DNA to silica in approximately 8 M NaI solutions and in NaCl solutions at or above about 2 M at pH 5.2 has also been documented. The NaCl concentration dependence of silica adsorption for DNA and RNA ladder samples was confirmed. DNA restriction fragments (100 bp ladder sample containing DNA of 100-1517 bp) and RNA fragments (ssRNA ladder containing RNA of 500-9000 bases; not shown) were found to bind to silica in unbuffered (pH ca. 5.5-7.0) 2 M NaCl (FIG. 7). Thus DNA and RNA, as with unsulfated GAGs chondroitin and heparosan, can be removed from HA by adsorption to silica in 2 M NaCl, before or after HA isolation.

Biological fluids or extracts should generally be pretreated with a protease such as proteinase K. After proteinase K treatment, boiling to denature the enzyme (which does not cause HA degradation) and either centrifugation at 20,000×g or filtering through an empty spin column with 20 μm pore size may be used to clarify the sample before proceeding to adding NaCl prior to silica adsorption. The proteinase K digestion solvent should contain an approximately physiological concentration of NaCl. Other proteases may be used, but any enzyme such as papain requiring a redox-active agent like cysteine for activation can lead to HA degradation.

### DISCUSSION

The method for isolation of HA by selective control of adsorption to silica and subsequent elution is based on concepts used in isolation of DNA and RNA, but with surprising differences.

The surface of amorphous silica has siloxane bridges (Si—O—Si) and silanol (Si—OH and Si—O⁻) groups. The silanols can be isolated, geminal (two OH bonded to the same Si), or vicinal. Siloxane bridges provide a hydrophobic surface aspect, whereas Si—OH act as hydrogen bond donors for water and biopolymers. The pKa for the silanol groups ranges from about 4.5-8.5, with an apparent pKa of about 7.5 in the presence of bound polyanions. The net charge remains negative under the conditions used in binding DNA or HA.

Binding of anionic biopolymers to silica requires minimization of electrostatic repulsion, and is therefore pH and ionic strength dependent. Optimum binding is at pH less than 7. At pH greater than 7 the net repulsion disfavors binding polyanions. Salt concentration can increase binding at a given pH by reducing repulsion.

For DNA, the driving force for silica binding is significantly entropic, and has been described as a type of hydrophobic interaction between DNA bases and regions of the silica surface poor in silanols. In physiological aqueous solutions, the surface of silica is highly hydrated by water molecules, up to several monolayers thick. Chaotropic salts are used to enhance DNA binding by disrupting ordered water at the polyanion and silica surfaces, allowing closer approach of DNA to silica.

Once in close proximity to the silica surface, DNA becomes hydrogen bonded to silica. Binding of DNA to silica is slightly exothermic, reflecting formation of H bonds, and thus binding is favored at lower temperatures.

Once bound, DNA can be hard to elute. In part, this may reflect DNA penetration into the pores of amorphous silica particles. Elevated temperature can increase recovery. NaOH has also been used to help elute DNA, and has been proposed to cause silica dissolution sufficient to release DNA.

HA adsorption to silica has some similarities to that of DNA but also significant differences. Similarities include increased binding at pH less than 7, and at high ionic strength. Significant differences, that were not anticipated, include: 1) HA does not bind silica in chaotropic salt solutions like GuHCl or GuSCN. Thus the binding is not favored by disruption of ordered water at silica and polyanion surfaces, and not stabilized by hydrophobic interactions, despite the existence of hydrophobicity at the surfaces above and below glucose-based pyranose rings. 2) The salt dependence of polyanion binding is not correlated with linear charge density and the electrostatic repulsion from silica. DNA has a linear charge density of 6 negative charges per nm, while sulfated GAGs have 2-4 negative charges per nm, and HA, CH, and HN all have only 1 negative charge per nm but binding affinity in salt solutions is CH, HN, DNA>HA>>sGAGs (HA needs a higher NaCl concentration to bind silica, despite the much lower linear charge density than DNA and thus weaker repulsion.) 3) Base and elevated temperatures aid elution, but the mechanism is not dissolution of silica. For HA, NaOH increases chain flexibility by ionizing hydroxyl groups and reducing intrachain H bonding.

These differences suggest a fundamental difference in binding mechanism for HA or other unsulfated GAGs versus DNA, possibly mediated by ordered water layers between silica and HA, CH, or HN. Water near the surface of amorphous silica has a reduced density for distances up to about 8 nm from the surface and ordered water clusters can mediate interactions between polyanions and silica. A similar effect has been reported for HA on crystalline mica surfaces (mica being an aluminosilicate), where HA has been found to bind epitaxially to an ordered water layer which is epitaxially bound to mica. In addition, fit of the GAG structure to the ordered water layer on silica may be important. On a rough surface of amorphous silica, biomolecules can differ in fit and surface recognition. It is proposed that CH and HN have slightly better fit than HA, and therefore require less NaCl to minimize repulsion. In contrast, sGAG failure to bind under any conditions tested suggests poor fit to silica surface due to the bulky sulfate groups, as well as lower inherent flexibility, and the reduced availability of H bond donating hydroxyl groups.

The unexpected behavior of HA and other GAGs in binding to silica means it has not previously been possible to predict or identify combinations of solid phase support and solvent conditions that would allow simple and rapid selective isolation of HA from other glycosaminoglycans of similar structure, or HA from nucleic acids.

The selective and reversible adsorption of HA of all sizes from dilute solutions to amorphous silica as described here differs from the previously reported deposition of HA onto silica disks using spin coating and drying of concentrated solutions of high M HA in distilled water, forming a thick layer of entangled polymer chains.

In summary, described herein is a simple and rapid procedure for selective isolation of HA from biological samples, while maintaining its size distribution, ranging at least from approximately 9 kDa to several MDa, which is important to its biological function. The method avoids the use of toxic organic materials like phenol or chloroform. Closely related molecules like sulfated glycosaminoglycans and the unsulfated glycosaminoglycan chondroitin are separated from HA by proper choice of solvent ionic strength and composition. The isolated HA so obtained is suitable for analysis of quantity and molecular mass distribution, and may be further fractionated by size using multiple different methods, enabling its use as a biomarker in medical diagnostics.

Although the present disclosure has been described through various embodiments, routine modifications will be apparent to those skilled in the art, which modifications are intended to be included within the scope of the present disclosure.

1. A method of separating hyaluronan (HA) from a biological fluid or biological solid sample comprising:
contacting the sample with silica in a binding solution, wherein the binding solution is an aqueous solution comprising a salt at a concentration greater than or equal to 2 M, wherein the HA binds to the silica;
washing the silica with a washing solution to remove unbound materials; and
eluting the bound HA from the silica with an elution solution,
wherein the concentration of sulfated glycosaminoglycans of the eluted HA sample is at least 90% less than the concentration of the sulfated glycosaminoglycans of the sample prior to the contacting the sample with silica.

2. The method of claim 1, wherein the sample is serum, urine, lymphatic fluid, cerebrospinal fluid (CSF), saliva, sputum, bronchoalveolar lavage fluid, or plasma.

3. The method of claim 1, wherein the sample is conditioned medium from cells in culture or solid tissue samples and/or extracts thereof, cultured cells, or cultured organoids.

4. The method of claim 1, wherein the salt of the binding solution is chosen from a NaCl aqueous solution and a NaI aqueous solution.

5. The method of claim 1, wherein the method does not comprise using a chaotropic agent chosen from guanidinium hydrochloride and guanidinium isothiocyanate.

6. The method of claim 1, wherein the method does not comprise protein removal using a solvent or solution comprising phenol or chloroform.

7. The method of claim 1, wherein the method does not comprise utilizing a nuclease.

8. The method of claim 1, wherein the HA has a mass from 4 to 10,000 kDa.

9. The method of claim 1, wherein the silica comprises amorphous particles or is microcrystalline.

10. The method of claim 1, wherein the silica is disposed or bound on a portion of a surface of or in a microcentrifuge tube, a microfluidics device, a bead, a multi-well plate, or a mini spin column.

11. The method of claim 4, wherein the NaCl aqueous solution is greater than or equal to 4-5.5 M NaCl.

12. The method of claim 4, wherein the NaCl aqueous solution is greater than or equal to 2.5 M NaCl.

13. The method of claim 4, wherein the NaI aqueous solution is from 3-5 M NaI.

14. The method of claim 1, wherein the binding solution has a pH of 5.5-7.5.

15. The method of claim 1, wherein the washing solution is an aqueous solution comprising 5 mM Tris and 0.5 mM EDTA, with a pH of about 7 and at least 75% by volume ethanol or at least 50% by volume trifluoroethanol or at least 50% by volume isopropanol.

16. The method of claim 1, wherein the elution solution is an aqueous solution comprising 10 mM Tris and 1 mM EDTA, wherein the pH is 7-8.

17. The method of claim 1, wherein the eluting step is followed by one or more additional eluting steps at a temperature of from 4° C. to room temperature for a period of from 20 minutes to overnight.

18. The method of claim 1, wherein the eluting is a single step comprising contacting the washed silica with a strong base, and wherein the strong base is chosen from NaOH and KOH.

19. The method of claim 1, wherein the eluting is performed at 37° C.

20. A method of separating hyaluronan (HA) from a biological fluid or biological solid sample comprising:
contacting the sample with silica in a binding solution, wherein the binding solution is an aqueous solution comprising a salt at a concentration greater than or equal to 2 M, wherein the HA binds to the silica;
washing the silica with a washing solution to remove unbound materials;
contacting the sample with the silica in a second binding solution, wherein the second binding solution is an aqueous solution comprising a salt at a concentration greater than or equal to 4 M, wherein the HA remains bound to the silica; and,
eluting the bound HA from the silica with an elution solution,
wherein the concentration of sulfated glycosaminoglycans of the eluted HA sample is at least 90% less than the concentration of the sulfated glycosaminoglycans of the sample prior to the contacting the sample with silica.
